(19) United States
(12) Patent Application Publication
(10) Pub. No.: US 2009/0148212 A1
(43) Pub. Date: Jun. 11, 2009

(54) FIXING DEVICE

(75) Inventor: Satoshi HIMENO, Shizuoka (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/327,645

(22) Filed: Dec. 3, 2008

Related U.S. Application Data
(60) Provisional application No. 61/012,773, filed on Dec. 10, 2007.

(51) Int. Cl. G03G 15/00

(52) U.S. Cl. 399/400

(57) ABSTRACT

An embodiment provides plural rollers that rotate by sliding contact with a sheet of paper on a fixing guide. The sheet of paper supporting a toner image is guided toward a nip position of a fixing roller along the rollers of the fixing guide. At guiding by the fixing guide, the sheet of paper is not contact with a guide plate.

### CROSS-REFERENCE TO RELATED APPLICATION

This application is based upon and claims the benefit of priority from provisional U.S. Application 61/012,773 filed on Dec. 10, 2007, the entire contents of which are incorporated herein by reference.

### TECHNICAL FIELD

The present invention relates to a fixing device that fixes toner images on recording media in a copier, printer, or the like.

### BACKGROUND

An image forming apparatus such as a copier or a printer mounts a fixing device that nips and carries sheets of paper for fixing. Such a fixing device allows sheets of paper to pass between rollers of a heating roller and a pressing roller, for example, or in a nip position direction formed between belts for the similar roles and fixes toner images by applying heat and pressure to them. A carrying guide that guides the sheets of paper to the nip position conventionally uses a stationary flat plate of a metal plate or mold. Alternatively, rollers are provided in part of such a stationary flat plate. The carrying guide reliably feeds sheets of paper to the nip position. Thereby, image blurring and paper wrinkles are prevented at fixing.

However, in the conventional carrying guide, flying toner and toner adhering to the back of the sheets of paper attach to the flat plate part and gradually become deposited. Due to the toner attached to and further deposited on the flat plate part, the accuracy of the carrying guide to guide the sheets of paper becomes lower and image blurring and paper wrinkles may be caused. Alternatively, due to the toner attached to and further deposited on the flat plate part, smudges on the back of paper or jamming may be caused.

Accordingly, toner attachment to the carrying guide is suppressed. After all, development of a fixing device with which good fixed images without image blurring or paper wrinkles can be obtained and smudges on the back of paper and jamming can be prevented is designed.

### SUMMARY

An aspect of the invention is to suppress toner attachment to the carrying guide regardless of flying toner or toner adhering to the back of sheets of paper. Good fixed images can be obtained and smudges on the back of paper and jamming can be prevented.

According to embodiments, a fixing device includes a fixing member that nips and carries a recording medium supporting an image and fixes the image, and a guide member having plural rotating members provided in plural rows in a travelling direction of the recording medium from a transfer position where the image is transferred onto the recording medium toward the fixing member and in plural rows in a width direction of the recording medium, and slidingly rotating in contact with the recording medium.

### DESCRIPTION OF THE DRAWINGS

FIG. 1 is a schematic configuration diagram showing an image forming apparatus on which a fixing device of an embodiment of the invention is mounted;

FIG. 2 is a schematic side view showing a fixing unit of the embodiment of the invention;

FIG. 3 is a schematic perspective view showing a fixing guide of the embodiment of the invention;

FIG. 4 is a schematic explanatory diagram showing the fixing guide of the embodiment of the invention;

FIG. 5 is a schematic explanatory diagram showing arrangement of rollers and ribs of the fixing guide of the embodiment of the invention;

FIG. 6 is a schematic explanatory diagram showing star wheels of a first modified example of the invention;

FIG. 7 is a schematic explanatory diagram showing a fixing guide of a second modified example of the invention; and

FIG. 8 is a schematic explanatory diagram showing a fixing guide of a third modified example of the invention.

### DETAILED DESCRIPTION

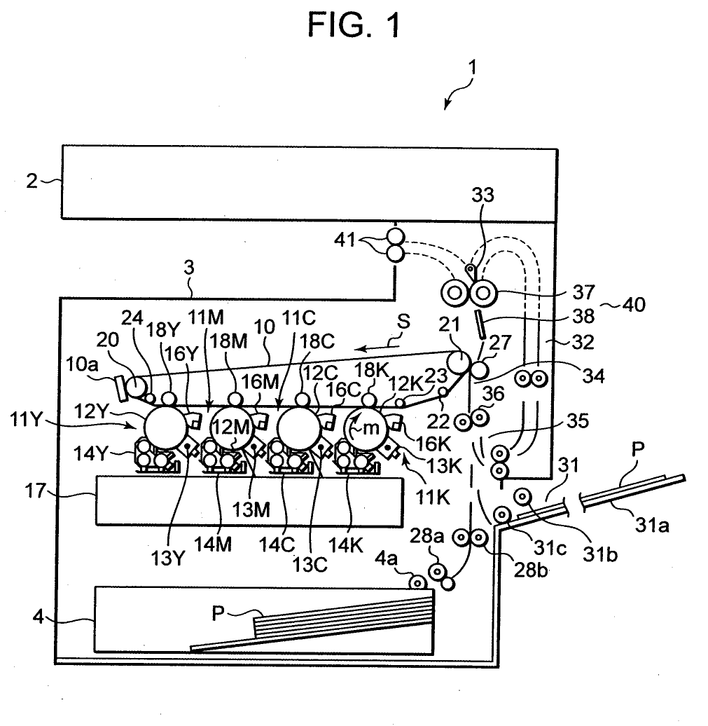

As below, an embodiment of the invention will be described in detail taking the accompanying drawings as examples. FIG. 1 is a schematic configuration diagram showing a four-drum tandem color copier 1 as an image forming apparatus of an embodiment. The color copier 1 includes a scanner unit 2 and a paper discharge unit 3 in the upper part. The color copier 1 has an image forming unit 11 as a image forming member including four sets of image forming stations 11Y, 11M, 11C and 11K of yellow (Y) magenta (M), cyan (C), black (K) arranged in juxtaposition along the lower part of an intermediate transfer belt 10 as an image carrier.

The image forming stations 11Y, 11M, 11C and 11K have photoconductive drums 12Y, 12M, 12C and 12K, respectively. Around the photoconductive drums 12Y, 12M, 12C and 12K, charging chargers 13Y, 13M, 13C and 13K, developing devices 14Y, 14M, 14C and 14K, and photoconductor cleaning devices 16Y, 16M, 16C and 16K are provided along the rotational direction of arrow m, respectively. Exposure lights by a laser exposure device 17 are applied to parts between the respective charging chargers 13Y, 13M, 13C and 13K to the developing devices 14Y, 14M, 14C and 14K around the photoconductive drums 12Y, 12M, 12C and 12K. When the exposure light is applied, electrostatic latent images are formed on the photoconductive drums 12Y, 12M, 12C and 12K, respectively.

The developing devices 14Y, 14M, 14C and 14K have two-component developers containing respective yellow (Y) toner, magenta (M) toner, cyan (C) toner or black (K) toner and carrier, respectively. The respective developing devices 14Y, 14M, 14C and 14K supply toner to the electrostatic latent images on the photoconductive drums 12Y, 12M, 12C and 12K, respectively.

The intermediate transfer belt 10 is hung with tension by a backup roller 21, a driven roller 20 and first to third tension rollers 22 to 24. The intermediate transfer belt 10 faces in contact with the photoconductive drums 12Y, 12M, 12C and 12K. In positions of the intermediate transfer belt 10 facing the photoconductive drums 12Y, 12M, 12C and 12K, primary transfer rollers 18Y, 18M, 18C and 18K for primary transfer of toner images as the images formed on the photoconductive drums 12Y, 12M, 12C and 12K onto the intermediate transfer belt 10 are provided.

In a secondary transfer part as a transfer position supported by the backup roller 21 of the intermediate transfer belt 10, a secondary transfer roller 27 as a transfer roller member and as a transfer member is provided. In the secondary transfer part, a predetermined secondary transfer bias is applied to the backup roller 21. While a sheet of paper as a recording medium is nipped and carried between the intermediate transfer belt 10 and the secondary transfer roller 27, the toner image on the intermediate transfer belt 10 is secondary-transferred thereon. After the secondary transfer, the intermediate transfer belt 10 is cleaned by a belt cleaner 10a.

A paper feed cassette 4 for feeding sheets of paper toward the secondary transfer roller 27 is provided below the laser exposure device 17. On the right side of the color copier 1, a manual feed mechanism 31 for manually feeding sheets of paper is provided.

A pickup roller 4a, a separating roller 28a, a carrying roller 28b and a resist roller 36 are provided in a part from the paper feed cassette 4 to the secondary transfer roller 27. A manual paper feed pickup roller 31b and a manual feed separating roller 31c are provided in a part from a manual feed tray 31a of the manual feed mechanism 31 to the resist roller 36.

A fixing unit 40 is provided at the downstream of the secondary transfer part along the traveling direction of the sheet of paper P. The fixing unit 40 has a fixing roller 37 as a fixing member and a fixing guide 38 as a guide member. The sheet of paper taken out from the paper feed cassette 4 or fed from the manual feed mechanism 31 is carried along a longitudinal carrying path 34 via the resist roller 36 and the secondary transfer roller 27 to the fixing unit 40.

A gate 33 is provided at the downstream of the fixing unit 40, and the sheets of paper are directed toward a paper discharge roller 41 or a re-carrying unit 32. The sheet of paper guided to the paper discharge roller 41 is discharged on the paper discharge unit 3. Further, the sheet of paper guided to the re-carrying unit 32 is guided toward the secondary transfer roller 27 again.

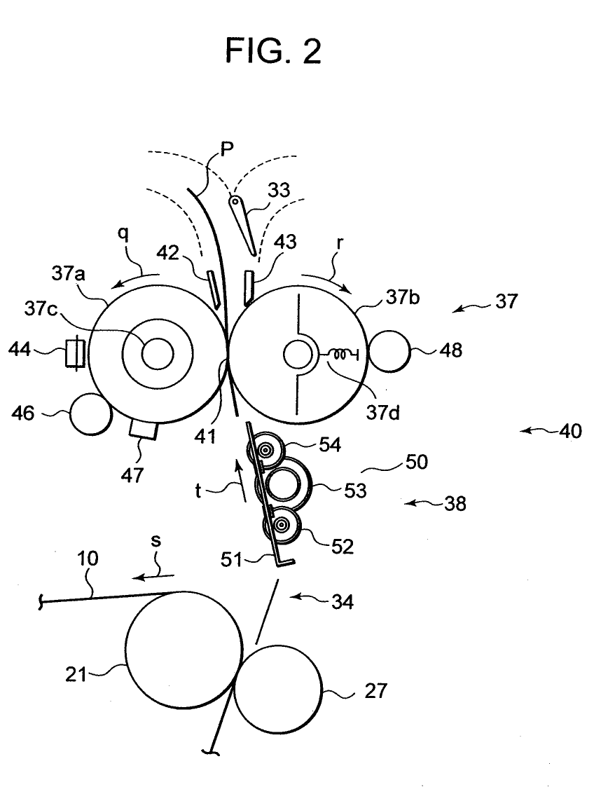

Next, the fixing unit 40 will be described in detail. FIG. 2 is a schematic configuration diagram of the fixing unit 40 seen from side. The fixing roller 37 has a heating roller 37a and a pressing roller 37b. The heating roller 37a has a heater lamp 37c in the hollow part inside. The pressing roller 37b is in contact with the heating roller 37a by a pressurizing mechanism 37d at predetermined pressure. Thereby, a nip 41 having a predetermined width is formed between the heating roller 37a and the pressing roller 37b.

The heating roller 37a is rotated in a direction of arrow q. The pressing roller 37b is drivenly rotated in a direction of arrow r due to pressure contact with the heating roller 37a. On the periphery of the heating roller 37a, a first separating claw 42 that releases the sheet of paper P passing through the nip 41 from the heat roller 37a is provided. Around the heating roller 37a, a temperature detection element 44, a first cleaning member 46 and an abnormal heating detection element 47 are provided at the downstream of the first separating claw 42 along the rotational direction of the heating roller 37a. On the periphery of the pressing roller 37b, a second separating claw 43 for separating the sheet of paper P from the pressing roller 37b and a second cleaning member 48 are provided along the rotational direction of the pressing roller 37b.

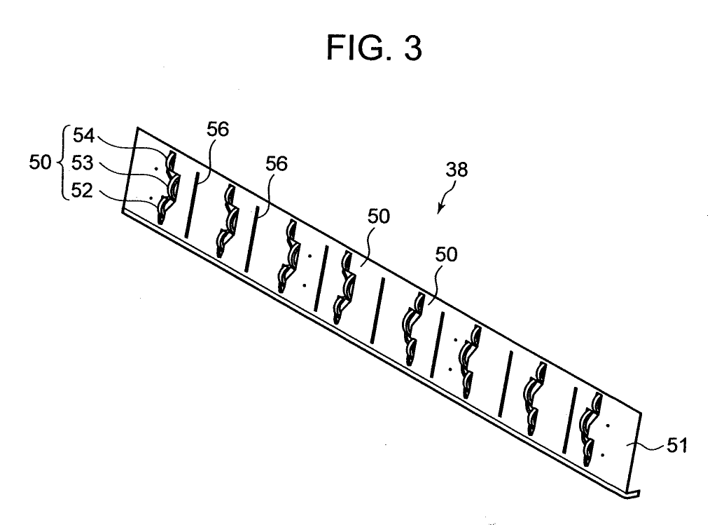

The fixing guide 38 is provided in the longitudinal carrying path 34 from the secondary transfer roller 27 to the fixing roller 37. The fixing guide 38 guides the sheet of paper P on which the toner image is transferred by the secondary transfer roller 27 to the nip 41. As shown in FIG. 3 to FIG. 5, the fixing guide 38 has plural rollers 50 as plural rotating members and a guide plate 51 as a supporting member that supports the rollers 50. The rollers 50 are supported by the guide plate 51 to rotate by sliding contact with the sheet of paper P. The rollers 50 use BEAREE FE5101 manufactured by NTN corporation containing fluorine resin ETFE (copolymer of tetrafluoroethylene and ethylene), for example.

The rollers 50 includes total three rows of rollers 52 in the first row, rollers 53 in the second row and rollers 54 in the third row, for example, along a direction of arrow t as the traveling direction of the sheet of paper P. The rollers 50 are arranged in eight rows, for example, in the width direction of the sheet of paper P perpendicular to the direction of arrow t. The diameters of the rollers 52 in the first row and the rollers 54 in the third row are the same. The diameter of the rollers 53 in the second row provided between the rollers 52 in the first row and the rollers 54 in the third row is formed larger than the diameter of the rollers 52 in the first row and the rollers 54 in the third row. Note that the diameter sizes of the rollers in the three rows are arbitrary and all of the rollers in the three rows may have the same diameter.

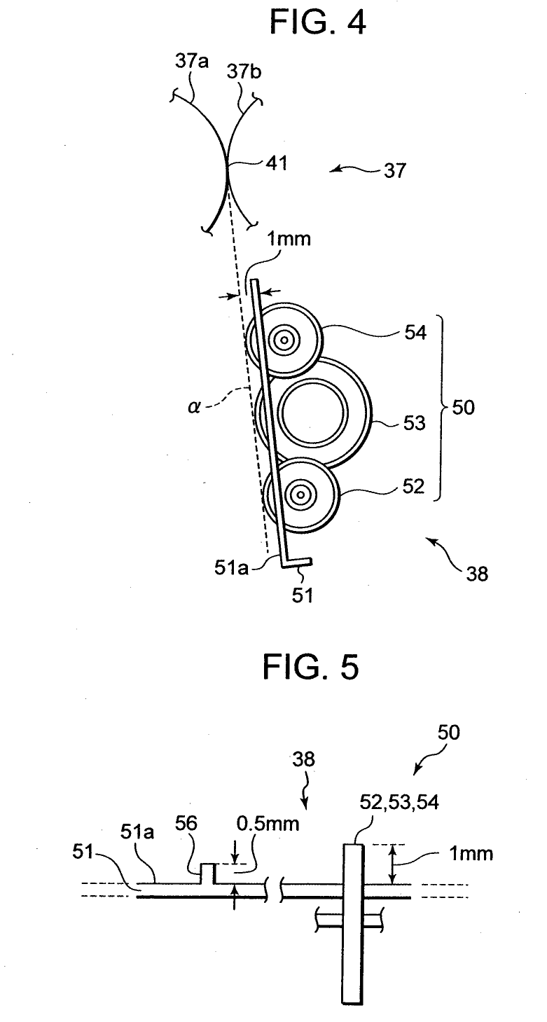

All amounts of protrusion of the rollers 52 in the first row to the rollers 54 in the third row from a supporting surface 51a of the guide plate 51 are the same. Accordingly, the surface in contact with the tops of the rollers 52 in the first row to the rollers 54 in the third row (the surface indicated by dotted line α in FIG. 4) is in parallel to the supporting surface 51a of the guide plate 51. The fixing guide 38 guides the sheet of paper P along the dotted line α. Thereby, the sheet of paper P is guided to the nip 41. The amount of protrusion of the rollers 50 from the supporting surface 51a of the guide plate 51 is set to 1 mm, for example.

On the guide plate 51, ribs 56 in parallel to the traveling direction of the sheet of paper P are provided. The ribs 56 are integrated with the guide plate 51 by integral molding, for example. As shown in FIG. 5, the height from the supporting surface 51a of the guide plate 51 to the tops of the rib 56 is lower than the amount of protrusion of the rollers 50 from the supporting surface 51a of the guide plate 51. The height from the supporting surface 51a of the guide plate 51 to the tops of the rib 56 is set to 0.5 mm, for example. The ribs 56 intervene between adjacent rollers 50 in the width direction of the sheet of paper P and support the curved part of the sheet of paper P. Thereby, in the width direction, increase in curvature of the sheet of paper P and occurrence of paper wrinkles are prevented.

Next, the operation of the guide unit 40 will be described. An image formation process is started in the color copier 1. In the image forming unit 11, toner images are formed on the photoconductive drums 12Y, 12M, 12C and 12K by the image forming stations 11Y, 11M, 11C and 11K of yellow (Y), magenta (M), cyan (C), black (K), respectively. The toner images on the respective photoconductive drums 12Y, 12M, 12C and 12K are sequentially transferred onto the intermediate transfer belt 10 to form a full-color toner image on the intermediate transfer belt 10.

The full-color toner image on the intermediate transfer belt 10 reaches the secondary transfer roller 27. In synchronization with the full-color toner image on the intermediate transfer belt 10, the sheet of paper P is carried between the intermediate transfer belt 10 and the secondary transfer roller 27. While the sheet of paper P passes between the intermediate transfer belt 10 and the secondary transfer roller 27, the toner image on the intermediate transfer belt 10 is transferred thereon. The sheet of paper P supporting the toner image is guided toward the nip 41 position of the fixing roller 37 by the fixing guide 38.

In this regard, the sheet of paper P is not brought in contact with the supporting surface 51a of the guide plate 51. The sheet of paper P is guided along the surface indicated by the dotted line a while being supported by the plural rollers 50 supported by the guide plate 51. Further, the plural rollers 50 are rotated with traveling of the sheet of paper P in the direction of arrow t. The sheet of paper P is supported not only by the rollers 50 but also by the ribs 56 according to its rigidity while being guided to the fixing guide 38.

If the toner attached to the secondary transfer roller 27 at secondary transfer adheres to the back of the sheet of paper P, the rollers 50 do not rub off the toner on the back of the sheet of paper P. The toner hardly adheres to the rollers 50 and the toner attachment to the fixing guide 38 is suppressed. Further, even if the toner adheres to the rollers 50, the rollers 50 slidingly rotate in contact with the sheet of paper P and do not hinder the traveling of the sheet of paper P in the direction of arrow t. That is, jamming does not occur because of the sheet of paper P caught by the toner attached to the rollers 50. Further, smudges on the back do not occur because of offset of the toner attached to the rollers 50 on the sheet of paper P. The sheet of paper P is guided with high accuracy toward the nip 41 position of the fixing roller 37 by the fixing guide 38.

The sheet of paper P guided toward the nip 41 position is nipped and carried by the heating roller 37a and the pressing roller 37b, and the toner image is fixed by heating and pressure. In this regard, there is no guide position shift of the sheet of paper P due to the attached toner to the fixing guide 38, and thus, image blurring and paper wrinkles at fixing do not occur.

After the toner image is fixed, the sheet of paper P is discharged through the gate 33 to the paper discharge unit 3 by the paper discharge roller 41 for single-side image printing.

For double-side image printing or multiple printing, the sheet of paper P is re-carried to the secondary transfer part via the re-carrying unit 32.

According to the embodiment, the sheet of paper P supporting the toner image is guided to the nip 41 along the surface indicated by dotted line α by the rollers 50 of the fixing guide 38. The sheet of paper P is prevented from being in contact with the guide plate 51. Thereby, toner attachment to the fixing guide 38 can be suppressed. The shift of the guide position of the sheet of paper P due to the attached toner of the fixing guide 38 can be prevented. The sheet of paper P is guided with high accuracy toward the nip 41 position of the fixing roller 37. As a result, good fixed images without image shift or paper wrinkles can be obtained. Further, the smudges on the back of the sheet of paper P and jamming due to the attached toner of the fixing guide 38 can be prevented. Furthermore, the ribs 56 are provided to suppress the curving of the sheet of paper P supported by the tops of the rollers 50. Thereby, the curving of the sheet of paper P is suppressed and occurrence of paper wrinkles at fixing is prevented.

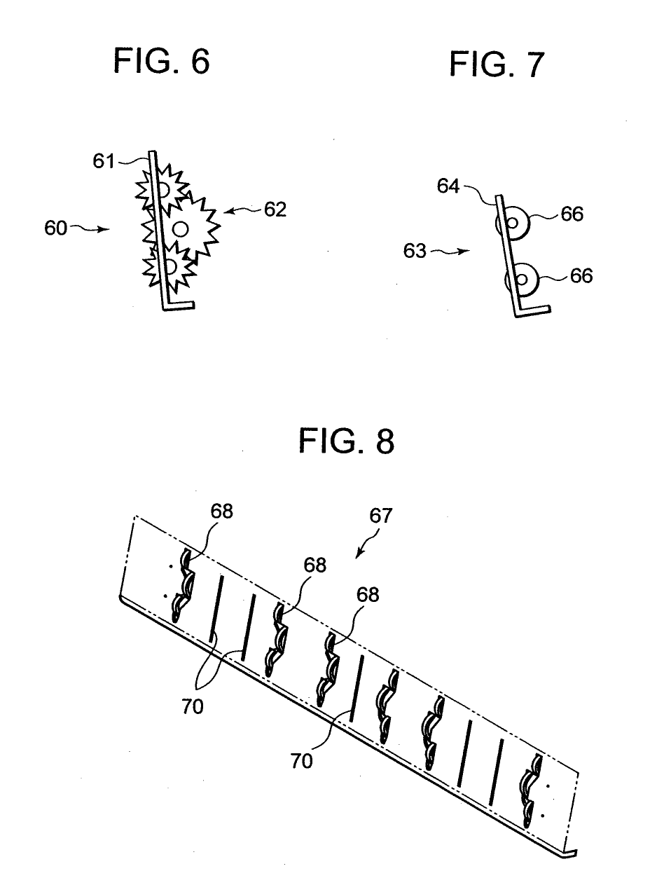

The invention is not limited to the embodiment and various changes can be made within the scope of the invention. For instance, the image forming apparatus may have any structure, and the guide member may guide the recording member in the horizontal direction. Further, the material and shape of the rotating member is not limited. For example, it may be formed by a mold member and a fluorine resin may be applied to the surface thereof. Furthermore, the rotating member may not have a roller shape. For example, as the first modified example shown in FIG. 6, rotating members 62 supported by a guide plate 61 of a fixing guide 60 may have star wheel shapes.

Moreover, the arrangement and number of the rotating members, the number of ribs, and the like are not limited. For example, the number of rows of rotating members along the traveling direction of the recording medium is not limited to three. Further, the number of rotating members in the width direction of the recording medium is not limited to seven. As the second modified example shown in FIG. 7, plural rollers 66 supported by a guide plate 64 of a fixing guide 63 may be arranged apart. As the third modified example shown in FIG. 8, ribs 70 may be provided in areas with wide intervals if intervals between rotating members 68 of a guide plate 67 are not uniform.

In addition, the amount of protrusion of the rotating member from the supporting surface of the supporting member is not limited. Note that, if the amount of protrusion of the rotating member from the supporting surface of the supporting member is greater, the curving of the recording member is greater and paper wrinkles become easier to occur. On this account, the amount of protrusion of the rotating member from the supporting surface of the supporting member is desirably set to 1 mm or less. Further, the height of the rib is not limited as long as it is lower than the amount of protrusion of the rotating member. Furthermore, the shape of the supporting member may be a frame shape, not the plate shape as long as it rotatably supports the plural rotating members.

What is claimed is:

1. A fixing device comprising:
a fixing member that nips and carries a recording medium supporting an image and fixes the image; and
a guide member having plural rotating members provided in plural rows in a traveling direction of the recording medium from a transfer position where the image is transferred onto the recording medium toward the fixing member and in plural rows in a width direction of the recording medium, and slidingly rotating in contact with the recording medium.

2. The device according to claim 1, wherein the plural rotating members are arranged so that a surface in contact with tops of the plural rotating members is in parallel to the traveling direction of the recording medium.

3. The device according to claim 1, wherein the guide member supports the plural rotating members by a supporting member in parallel to the traveling direction of the recording medium and the plural rotating members are protruded from a supporting surface of the supporting member.

4. The device according to claim 3, wherein the surface in contact with the tops of the plural rotating members is in parallel to the supporting surface.

5. The device according to claim 3, wherein the height to which the plural rotating members are protruded from the supporting surface is 1 mm or less.

6. The device according to claim 3, wherein the supporting member further comprising a rib in parallel to the traveling direction.

7. The device according to claim 6, wherein the height to which the plural rotating members are protruded from the supporting surface is higher than a height of the rib.

8. The device according to claim 1, wherein the plural rotating members have roller shapes.

9. The device according to claim 1, wherein the plural rotating members have star wheel shapes.

10. The device according to claim 1, wherein the plural rotating members are formed by a fluorine material.

11. An image forming apparatus comprising:
an image forming member that forms an image on an image carrier;
a transfer member that transfers the image onto a recording medium;
a fixing member that nips and carries the recording medium and fixes the image; and
a guide member having plural rotating members provided in plural rows in a traveling direction of the recording medium from the transfer member toward the fixing member and in plural rows in a width direction of the recording medium, and slidingly rotating in contact with the recording medium.

12. The apparatus according to claim 11, wherein the transfer member is a transfer roller member that nips and carries the recording medium between the image carrier and itself.

13. The apparatus according to claim 11, wherein the plural rotating members are arranged so that a surface in contact with tops of the plural rotating members is in parallel to the traveling direction of the recording medium.

14. The apparatus according to claim 11, wherein the guide member supports the plural rotating members by a supporting member in parallel to the traveling direction of the recording medium and the plural rotating members are protruded from a supporting surface of the supporting member.

15. The apparatus according to claim 14, wherein the surface in contact with the tops of the plural rotating members is in parallel to the supporting surface.

16. The apparatus according to claim 14, wherein the supporting member further has a rib in parallel to the traveling direction.

17. The apparatus according to claim 16, wherein the height to which the plural rotating members are protruded from the supporting surface is higher than a height of the rib.

18. The apparatus according to claim 11, wherein the plural rotating members have roller shapes.

19. The apparatus according to claim 11, wherein the plural rotating members have star wheel shapes.

20. The apparatus according to claim 11, wherein the plural rotating members are formed by a fluorine material.
